(19) United States
(12) Patent Application Publication
(10) Pub. No.: US 2022/0092892 A1
(43) Pub. Date: Mar. 24, 2022

(54) PROCESSING METHOD AND APPARATUS FOR USE WHEN AGV IS ABNORMAL, ELECTRONIC DEVICE, AND STORAGE MEDIUM

(71) Applicant: BEIJING JINGDONG QIANSHI TECHNOLOGY CO., LTD., Beijing (CN)

(72) Inventors: Hengbin Zhu, Beijing (CN); Yuanhui Lang, Beijing (CN)

(73) Assignee: BEIJING JINGDONG QIANSHI TECHNOLOGY CO., LTD., Beijing (CN)

(21) Appl. No.: 17/425,499

(22) PCT Filed: Jan. 2, 2020
(86) PCT No.: PCT/CN2020/070081

§ 371 Date: Jul. 23, 2021

(30) Foreign Application Priority Data
Jan. 29, 2019 (CN) 201910085917.9

(51) Int. Cl. G07C 5/08; G05D 1/00; G05D 1/02

(52) U.S. Cl. CPC G07C 5/0808; G05D 1/0287; G05D 1/0212; G05D 1/0088

(57) ABSTRACT

Provided are an anomaly processing method and apparatus of an automated guided vehicle (AGV), an electronic device, and a storage medium. The processing method includes receiving anomaly processing information sent by an AGV control device when a first AGV is abnormal; determining, according to the anomaly processing information, an area affected when the first AGV is abnormal; locking the determined area; and unlocking the locked area when the anomaly processing ends.

This application claims priority to Chinese Patent Application No. 201910085917.9 filed with the CNIPA on Jan. 29, 2019 and entitled “PROCESSING METHOD AND APPARATUS FOR USE WHEN AGV IS ABNORMAL, ELECTRONIC DEVICE, AND STORAGE MEDIUM”, the disclosure of which is incorporated herein by reference in its entirety.

### TECHNICAL FIELD

The present application relates to the field of logistics technology and, in particular, to an anomaly processing method and apparatus of an AGV, an electronic device, and a storage medium.

### BACKGROUND

In intelligent logistics, a common solution to the automated package sorting and conveying operation in an unmanned warehouse is to intelligently dispatch a plurality of automated guided vehicles (AGVs) through a dispatching system such that the AGVs convey packages to specified destinations according to the preset route planning It is inevitable in such an operation mode that the AGVs may have various anomalies during operation. Since the consequent effect of an anomaly is uncertain, a faulty AGV needs to be processed timely. Generally, when an anomaly occurs, all the AGVs on the entire site are stopped immediately to minimize the effect range and enable an operator to enter the site conveniently and safely to process the anomaly.

### SUMMARY

Embodiments of the present application provide an anomaly processing method and apparatus of an AGV, an electronic device, and a storage medium. In this case, the effect of an AGV anomaly is mitigated and the operating efficiency of AGVs on the entire site is enhanced.

The solutions of the present application are described hereinafter.

Embodiments of the present application provide an anomaly processing method of an AGV. The method includes the steps below.

The anomaly processing information sent by an AGV control device is received in response to a first AGV being abnormal.

An affected area in response to the first AGV being abnormal is determined according to the anomaly processing information.

The determined area is locked.

The locked area is unlocked in response to the anomaly processing ending.

Embodiments of the present application further provide an anomaly processing apparatus of an AGV. The apparatus includes a receiving unit, a determination unit, a locking unit, and an unlocking unit.

The receiving unit is configured to receive the anomaly processing information sent by the AGV control device when the first AGV is abnormal.

The determination unit is configured to determine, according to the anomaly processing information received by the receiving unit, the area affected when the first AGV is abnormal.

The locking unit is configured to lock the area determined by the determination unit.

The unlocking unit is configured to unlock the locked area when the abnormal processing ends.

Embodiments of the present application further provide an electronic device. The electronic device includes a memory, a processor, and computer programs stored on the memory and executable on the processor. The processor performs the steps of the anomaly processing method of an AGV when executing the computer program.

Embodiments of the present application further provide a non-volatile computer-readable storage medium storing the computer program. When executed by the processor, the computer program causes the steps of the anomaly processing method of an AGV to be performed.

According to the preceding technical solutions, in the present application, an area affected when an AGV is abnormal is determined according to anomaly processing information sent when the AGV is abnormal, and then the area is locked; when the anomaly processing ends, the locked area is unlocked. In the solutions, only the areas related to the abnormal AGV are locked, thereby mitigating the effect of the AGV anomaly and enhancing the operating efficiency of AGVs on the entire site.

### BRIEF DESCRIPTION OF DRAWINGS

FIG. 1 is a flowchart of anomaly processing of an AGV according to embodiments of the present application.

FIGS. 2A to 2C are each a flowchart of determining an area affected when a first AGV is abnormal according to embodiments of the present application.

FIG. 3 is another flowchart of an anomaly processing method of an AGV according to embodiments of the present application.

FIG. 4 is another flowchart of an anomaly processing method of an AGV according to embodiments of the present application.

FIG. 5 is a diagram illustrating the structure of an anomaly processing apparatus of an AGV according to embodiments of the present application.

FIG. 6 is another diagram illustrating the structure of an anomaly processing apparatus of an AGV according to embodiments of the present application.

FIG. 7 is another diagram illustrating the structure of an anomaly processing apparatus of an AGV according to embodiments of the present application.

FIG. 8 is a diagram illustrating the structure of an electronic device according to embodiments of the present application.

### DETAILED DESCRIPTION

To provide a clearer understanding of objects, technical solutions, and advantages of the present application, the technical solutions of the present application are described in detail hereinafter in conjunction with drawings and embodiments.

If an AGV has an anomaly during operation, according to the abnormal conveying operation, all the AGVs on the entire site need to stop to enable a manual intervention for troubleshooting. In this case, other AGVs that are not affected on the site have to stop, greatly reducing the conveying efficiency and thus delaying the entire operation. It is foreseeable that relatively frequent occurrence of anomalies within one day may have a more negative effect on the processing efficiency.

Embodiments of the present application provide an anomaly processing method of an AGV. An area affected when an AGV is abnormal is determined according to anomaly processing information sent when the AGV is abnormal, and then the area is locked; when the anomaly processing ends, the locked area is unlocked. In the solutions, only the areas related to the abnormal AGV are locked, thereby mitigating the effect of the AGV anomaly and enhancing the operating efficiency of AGVs on the entire site.

The AGV worksite in embodiments of the present application is a large area. When a plurality of AGVs perform the conveying operation collaboratively on the site, a sudden anomaly of a single AGV needs to be processed timely. The anomaly process of an AGV is provided hereinafter in conjunction with drawings.

In embodiments of the present application, the subject for processing an AGV anomaly is a processing apparatus. The processing apparatus may be a part of an AGV control device or a part of a central proxy server, which is related to the system architecture in a practical application.

When the entire system includes AGV control devices, a central proxy server, and AGVs, each AGV control device controls part of the AGVs such that all the AGV control devices control all the AGVs. The AGVs may also interact with the central proxy server. In such a system, the processing apparatus is provided in the central proxy server. Each AGV control device stores the information and working routes of the AGVs under the control of the each AGV control device. The central server stores the information and working routes of all AGVs.

When the entire system includes AGVs and one or a plurality of AGV control devices, the AGV control devices may communicate with each other. One AGV control device is selected as a master device to obtain the information and working routes of all AGVs. In such a system, the processing apparatus is provided in the AGV control device.

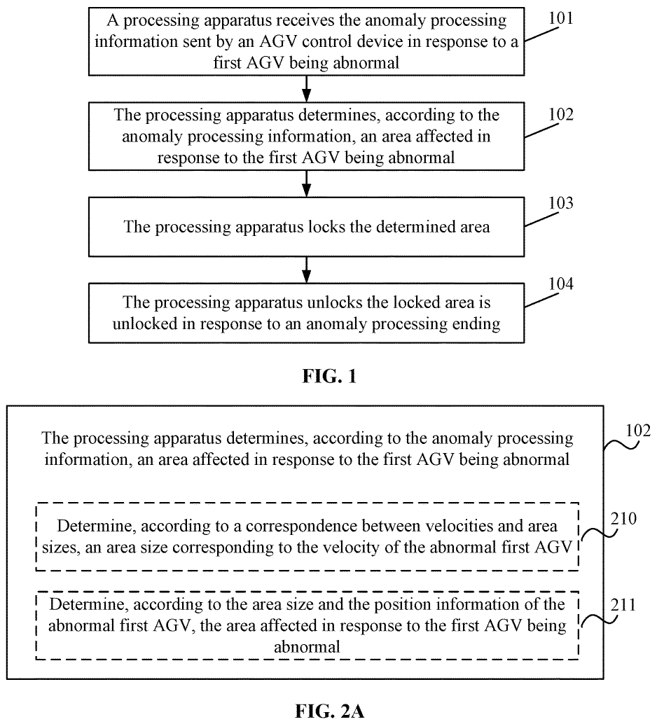

Referring to FIG. 1, FIG. 1 is a flowchart of anomaly processing of an AGV according to embodiments of the present application. The processing apparatus in the AGV control device or the central proxy server performs the steps below.

In step 101, the processing apparatus receives the anomaly processing information sent by an AGV control device in response to a first AGV being abnormal.

In step 102, the processing apparatus determines, according to the anomaly processing information, an area affected in response to the first AGV being abnormal.

In embodiments of the present application, step 102 has three implementations described below, but is not limited to the three implementations.

In a first implementation, the affected area is determined according to a preset correspondence between velocities and area sizes. A higher velocity corresponds to a larger area.

The correspondence between velocities and areas may be determined according to actual situations. If the number of values corresponding to possible velocities for AGV anomalies is relatively small, each velocity may be set to correspond to an area. If the number of values corresponding to possible velocities for AGV anomalies is relatively large, for example, larger than the preset data, each velocity range is set to correspond to an area.

In this implementation, the anomaly processing information received by the processing apparatus and sent by the AGV control device in step 101 includes the velocity of the abnormal first AGV and the position information of the abnormal first AGV.

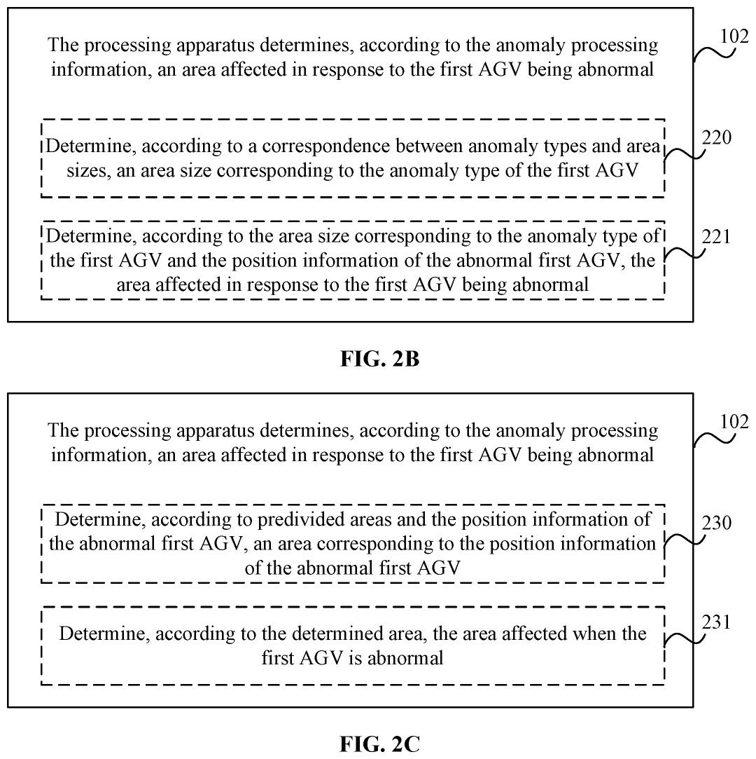

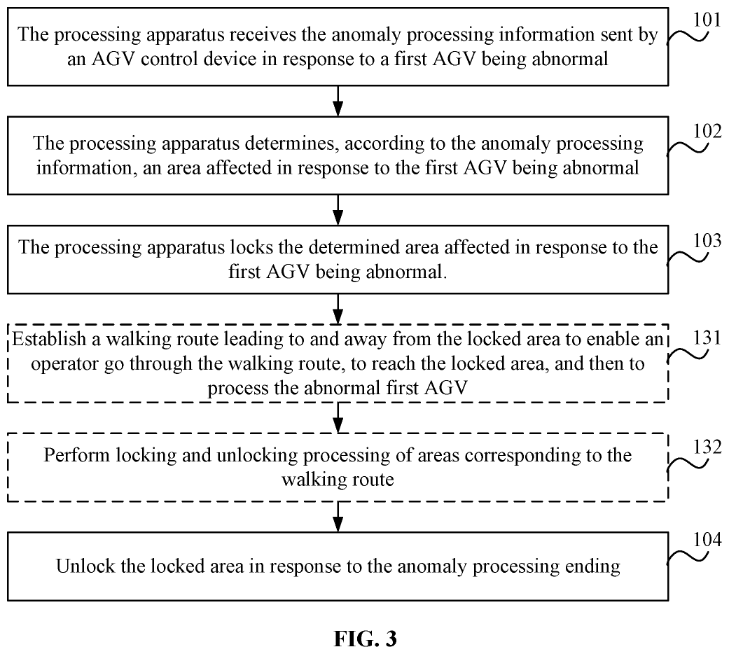

As shown in FIG. 2A, in step 102, the processing apparatus determines, according to the anomaly processing information, the area affected in response to the first AGV being abnormal, including steps below.

In step 210, an area size corresponding to the velocity of the abnormal first AGV is determined according to the correspondence between velocities and area sizes.

In step 211, the area affected in response to the first AGV being abnormal is determined according to the area size and the position information of the abnormal first AGV.

In a second implementation, a correspondence between anomaly types and area sizes is preset.

The anomaly types herein may be, for example, a derailment event, a navigation sensor communication interruption event, or a parking position anomaly event, but are not limited to the exemplified anomaly types.

In this implementation, the anomaly processing information received by the processing apparatus and sent by the AGV control device in step 101 includes the anomaly type and the position information of the abnormal first AGV.

As shown in FIG. 2B, in step 102, the processing apparatus determines, according to the anomaly processing information, the area affected in response to the first AGV being abnormal, including steps below.

In step 220, an area size corresponding to the anomaly type of the first AGV is determined according to the correspondence between anomaly types and area sizes.

In step 221, the area affected in response to the first AGV being abnormal is determined according to the area size corresponding to the anomaly type and the position information of the abnormal first AGV.

The first implementation and the second implementations are implementations where the area is determined dynamically.

In a third implementation, the site is predivided into a plurality of areas.

In some embodiments of the present application, the site may be divided into a plurality of areas according to any one of the following ways.

The site is evenly divided into N areas according to the preset number N of areas.

Alternatively, the site is divided according to functional areas of the site.

Areas after division may be a sorting area, a charging area, and a queuing area. The queuing area is an area in which the AGVs queue.

Alternatively, areas after division may be a sorting area, a charging area, and a plurality of workstation areas. The workstation areas are areas where an operator works.

The charging area and the queuing area belong to non-sorting areas. The charging area and the workstation areas belong to non-sorting areas. The site may also be divided into two areas, namely, a sorting area and a non-sorting area.

Nonetheless, the division is not limited to the preceding area functions and is determined according to the deployment of the actual scene.

In this implementation, the anomaly processing information received by the processing apparatus and sent by the AGV control device in step 101 includes the position information in response to the first AGV being abnormal.

As shown in FIG. 2C, in step 102, the processing apparatus determines, according to the anomaly processing information, the area affected in response to the first AGV being abnormal, including steps below.

In step 230, an area corresponding to the position information of the abnormal first AGV is determined according to the predivided areas and the position information of the abnormal first AGV.

In step 231, the area affected in response to the first AGV being abnormal is determined according to the determined area.

This implementation is an implementation where the area is determined statically.

In step 103, the processing apparatus locks the determined area affected in response to the first AGV being abnormal.

In embodiments of the present application, the method further includes, after locking the determined area, sending a notification that the determined area is locked so that the operator is prepared for processing the anomaly.

The notification may be given through, for example, a short message, a large-screen display on the site, or a voice notification and a large-screen display simultaneously.

In some embodiments, as shown in FIG. 3, after step 103, the method further includes steps below.

In step 131, a walking route leading to and away from the locked area is established to enable the operator to go through the walking route, to reach the locked area, and then to process the abnormal first AGV.

After the area is locked, a walking route needs to be established for the operator heading for and leaving the locked area so that the operator can reach the locked area to process the abnormal AGV.

In embodiments of the present application, a rules of establishing the walking route is as below.

The caused congestion is the slightest on the site.

Alternatively, the distance between the current position of the operator and the locked area is the shortest.

Alternatively, the distance from the locked area to the periphery of the site is the shortest. That is, the operator walks along the periphery of the site to the position at a shortest distance from the locked area, and then reaches the locked area along the planned route.

After establishing the walking route leading to and away from the locked area, the method further includes steps below.

A notification that the walking route is established is sent.

The notification may be given through, for example, a short message, a large-screen display on the site, or a voice notification and a large-screen display simultaneously.

In some embodiments, the operator, when heading for and leaving the locked area through the planned walking route, needs to lock and unlock areas corresponding to the walking route. As shown in FIG. 3, after step 131, the method further includes the steps below.

In step 132, areas corresponding to the walking route are locked and unlocked.

The locking and unlocking of the areas corresponding to the walking route specifically include processing modes below.

In a first mode, the areas corresponding to the walking route determined in step 131 are directly locked and unlocked as specifically described below.

In response to a lock command, all areas corresponding to the established walking route are locked.

In response to a unlock instruction, the all areas are unlocked.

When this processing mode of area locking is implemented, an AGV that needs to pass by the locked area may be re-dispatched or may be stopped when moving to the locked area. After the locked area is unlocked, the AGV re-starts moving.

In a second mode, according to the areas corresponding to the walking route determined in step 131, a handheld terminal is used for finding out the corresponding areas and lock points batch by batch dynamically. The specific implementation is described below.

In response to receiving a locking instruction sent by a handheld terminal, an area corresponding to the locking instruction is locked. In response to receiving an unlocking instruction sent by the handheld terminal, the locked area is unlocked.

Each time the received area to be locked is smaller than all areas corresponding to the walking route.

That is, part of the areas is locked. After passing an area, the operator locks another area to enter in the next step.

For example, in a specific implementation, the entire site is divided into areas by means of grids. Each grid may act as a point. The area locking may be performed taking a point as a basic unit. For example, three points are locked each time, indicating that the preceding area to be locked is an area corresponding to the three points.

For example, a point at an edge of the site is taken as a start. The operator scans the two-dimensional code of the point using the handheld terminal so that the current position is determined and locked. After the point is locked successfully, the operator enters a route of several points to be taken manually and applies for locking. If the locking succeeds, the operator may continue to walk along the locked route till reach the point at the end of the locking. Then the operator unlocks the locked points using the handheld terminal. The preceding process is circulated till the operator reaches the locked area of the anomaly. After the anomaly is processed, the operator performs the same operation to go out of the site. This mode has the advantage that part of the points may be locked and unlocked, thereby having relatively little effect on the site congestion.

In a third mode, the Wi-Fi electronic fence technology is applied and a plurality of APs at different positions are arranged on the site. The operator is positioned based on the handheld terminal of the operator. Then the real-time position of the operator is reported to the processing apparatus. The processing apparatus locks the point where the operator member is located in real time and releases the previously locked route that the operator has passed. In this case, the operator enters the locked area. The specific implementation is described below.

In response to receiving position information of the operator sent by a handheld terminal, an area corresponding to the position information is locked, and a locked area corresponding to position information previously received is unlocked.

The position information herein corresponds to an area corresponding to a minimum unit, for example, a point.

This mode has the advantage that the locking and unlocking may be implemented point by point, thereby having the least effect on the site congestion.

In a fourth mode, a device (for example, a walking trolley) with a higher driving priority and with the function of code-scanning and locking is taken for reaching and leaving the locked area. Specific steps are described below.

In response to receiving a locking instruction sent by the device with the function of code-scanning and locking, a corresponding area is locked. In response to receiving an unlocking instruction sent by the device, the locked area is unlocked.

In some embodiments, the device may be a walking trolley. The walking trolley advances in a manner of locking positions one by one and passing through areas corresponding to the route in a manner of releasing the locked positions one by one.

The operator takes a walking trolley with the function of code-scanning and locking to enter the locked area. The walling trolley has a higher priority in locking a point compared with an AGV. After the walking trolley enters the site, it locks one point each time when moving forward and unlocks the point after going through till reaching the locked areas. This mode has the advantage that the effect of site congestion is minimized.

The preceding operation enables the operator to reach and leave the locked area safely, quickly, and conveniently.

In step 104, the locked area is unlocked in response to the anomaly processing ending.

The processing apparatus may learn that the anomaly processing ends through, but is not limited to, the implementation below.

After the anomaly of the first AGV is processed, the first AGV feeds back to the processing apparatus. Alternatively, the operator feeds back that the processing apparatus is abnormal and waits for processing, etc.

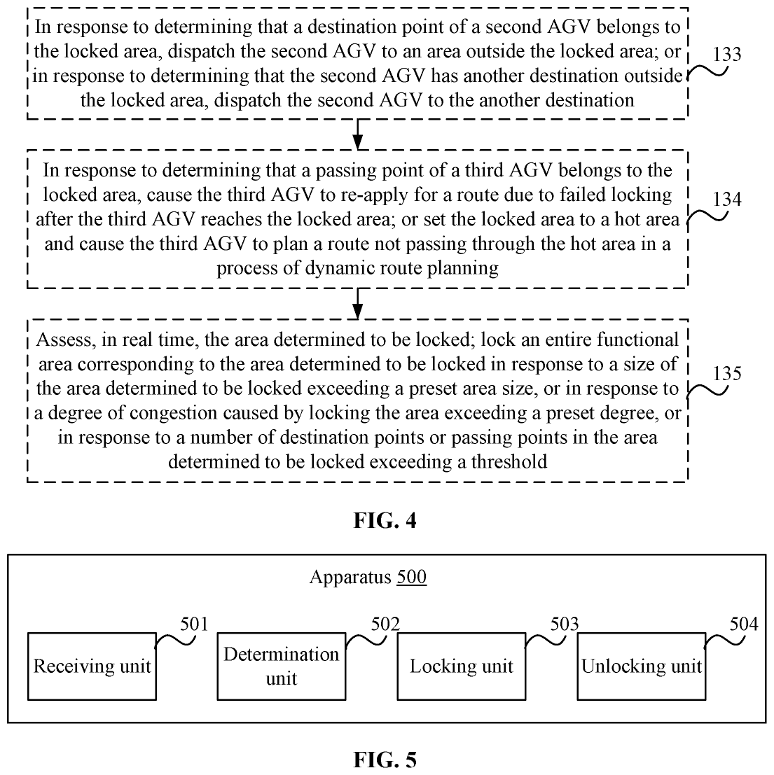

In this application, after the area is locked in step 103, the operator may deal with and dispatch other AGVs related to the area after entering the locked area to process the anomaly. As shown in FIG. 4, the method further includes the steps below.

In step 133, in response to determining that a destination point of a second AGV belongs to the locked area, the second AGV is dispatched to an area outside the locked area. Alternatively, in response to determining that the second AGV has another destination outside the locked area, the second AGV is dispatched to the destination outside the locked area.

The area outside the locked area may include a packet pausing point or a temporary parking point. The temporary parking point may be a free area determined according to the current operation of AGVs.

In step 134, in response to determining that a passing point of a third AGV belongs to the locked area, the third AGV is caused to re-apply for a route due to failed locking after reaching the locked area. Alternatively, the locked area is set to a hot area so that the third AGV is caused to keep away from the area and plan a route not passing through the area in the process of dynamic route planning.

In step 135, the processing apparatus assesses, in real time, an area to be locked and locks the entire functional area corresponding to the area to be locked in response to the degree of congestion caused by locking the area exceeding a preset degree, or in response to the size of the area to be locked exceeding the preset area size, or in response to the number of destination points or passing points in the locked area exceeding the threshold.

For example, the area to be locked may undoubtedly cause road congestion. Alternatively, the area to be locked is caused by a plurality of anomalies simultaneously overlapping. Moreover, the area to be locked undoubtedly exceeds the preset area size. The degree of consequent congestion exceeds the preset degree. When an AGV passes by the locked area or the destination of an AGV belongs to the locked area, the entire sorting area is locked.

This arrangement ensures the non-abnormal AGVs to operate normally or stop temporarily so that no additional anomalies occur, provides more assurance of the operation of AGVs on the entire site, and thus enhances the operating efficiency of AGVs on the entire site.

Based on the same concept, embodiments of the present application further provide an anomaly processing apparatus of an AGV. Referring to FIG. 5, FIG. 5 is a diagram illustrating the structure of an anomaly processing apparatus of an AGV according to embodiments of the present application. An apparatus 500 includes a receiving unit 501, a determination unit 502, a locking unit 503, and an unlocking unit 504.

The receiving unit 501 is configured to receive the anomaly processing information sent by an AGV control device when the first AGV is abnormal.

The determination unit 502 is configured to determine, according to the anomaly processing information received by the receiving unit 501, the area affected when the first AGV is abnormal.

The locking unit 503 is configured to lock the area determined by the determination unit 502.

The unlocking unit 504 is configured to unlock the locked area when the abnormal processing ends.

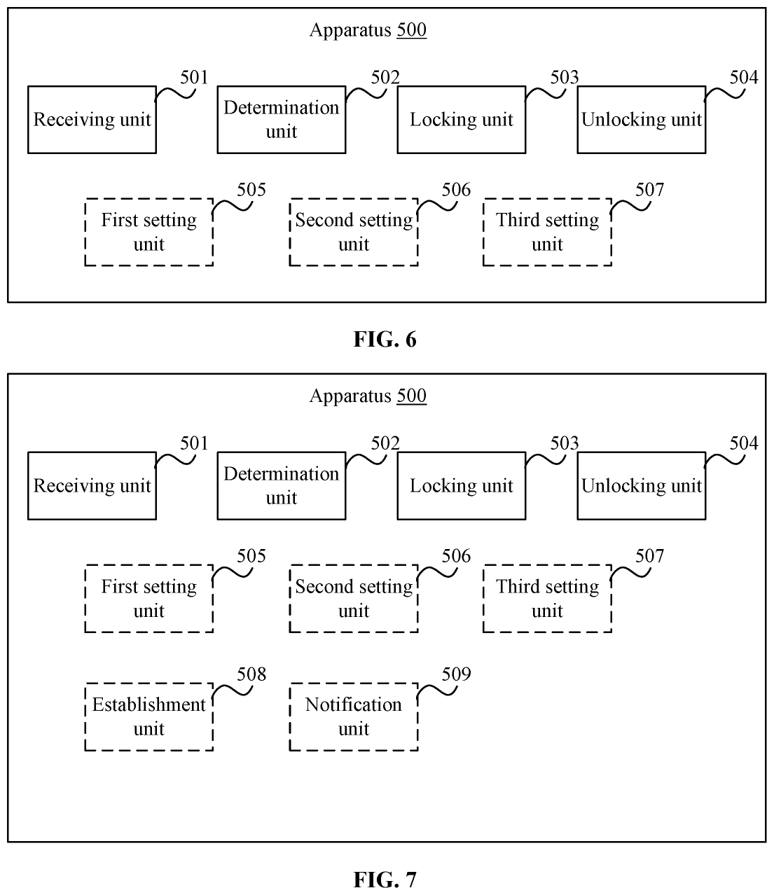

In some embodiments of the present application, as shown in FIG. 6, the apparatus further includes a first setting unit 505.

The first setting unit 505 is configured to preset a correspondence between velocities and area sizes. A higher velocity corresponds to a larger area.

The anomaly processing information received by the receiving unit 501 includes the velocity of the abnormal first AGV and the position information of the abnormal first AGV.

The determination unit 502 is further configured to determine, according to the correspondence between velocities and area sizes, the area size corresponding to the velocity of the abnormal first AGV and determine, according to the area size and the position information of the abnormal first AGV, the area affected when the first AGV is abnormal.

In some embodiments of the present application, as shown in FIG. 6, the apparatus further includes a second setting unit 506.

The second setting unit 506 is configured to preset a correspondence between anomaly types and area sizes.

The anomaly processing information received by the receiving unit 501 includes the anomaly type of the first AGV and the position information of the abnormal first AGV is abnormal.

The determination unit 502 is further configured to determine, according to the correspondence between anomaly types and area sizes, the area size corresponding to the anomaly type of the first AGV and determine, according to the area size corresponding to the anomaly type of the first AGV and the position information of the abnormal first AGV, the area affected when the first AGV is abnormal.

In some embodiments of the present application, as shown in FIG. 6, the apparatus further includes a third setting unit 507.

The third setting unit 507 is configured to predivide the site into a plurality of areas.

The anomaly processing information received by the receiving unit 501 includes the position information when the first AGV is abnormal.

The determination unit 502 is further configured to determine, according to the predivided areas and the position information of the abnormal first AGV, the area corresponding to the position information of the abnormal first AGV and determine, according to the area corresponding to the position information of the abnormal first AGV, the area affected when the first AGV is abnormal.

In some embodiments of the present application, the third setting unit 507 is further configured to divide the site according to functional areas of the site. Areas after division are a sorting area, a charging area, and a queuing area. Alternatively, areas after divisions are a sorting area, a charging area, and a plurality of workstation areas.

In some embodiments of the present application, after the locking unit 503 locks the determined area, the determination unit 502 is further configured to, in response to determining that the destination point of the second AGV belongs to the locked area, dispatch the second AGV to an area outside the locked area. Alternatively, in response to determining that the second AGV has another destination outside the locked area, the determination unit 502 dispatches the second AGV to the destination outside the locked area

The area outside the locked area may include a packet pausing point or a temporary parking point. The temporary parking point may be a free area determined according to the current operation of AGVs.

In some embodiments of the present application, after the locking unit 503 locks the determined area, the determination unit 502 is further configured to, in response to determining that a passing point of the third AGV belongs to the locked area, cause the third AGV to re-apply for a route due to failed locking after the third AGV reaches the locked area. Alternatively, the determination unit 502 sets the locked area to a hot area and causes the third AGV to plan a route not passing through the hot area in the process of dynamic route planning

In some embodiments of the present application, after the locking unit 503 locks the determined area, the determination unit 502 is further configured to, assess, in real time, the area determined to be locked, and lock the entire functional area corresponding to the area to be locked in response to the degree of congestion caused by locking the area exceeding the preset degree, or in response to the size of the area to be locked exceeding the preset area size, or in response to the number of destination points or passing points in the area to be locked exceeding the threshold.

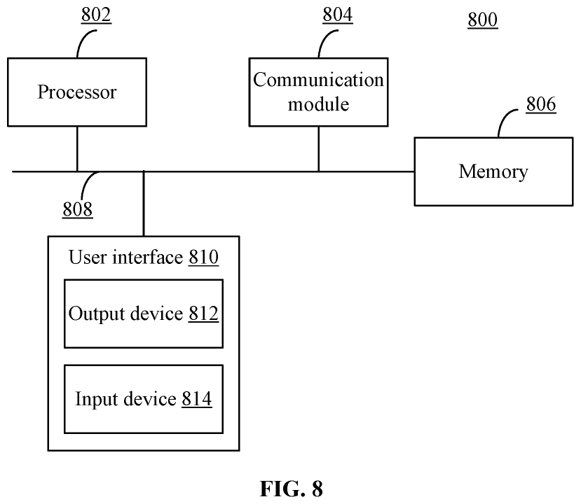

In some embodiments of the present application, as shown in FIG. 7, the apparatus further includes an establishment unit 508.

The establishment unit 508 is configured to establish a walking route leading to and away from the locked area locked by the locking unit 504. The locking unit 503 and the unlocking unit 504 are further configured to perform locking and unlocking process of areas corresponding to the walking route to enable, when the walking route is locked, the operator to go through the walking route, to reach the locked area, and then to process the first AGV that is abnormal.

In some embodiments of the present application, a rule of establishing the walking route is as follows: the caused congestion is the slightest on the site; alternatively, the distance between the current position of the operator and the locked area is the shortest; alternatively, the distance from the locked area to the periphery of the site is the shortest.

In some embodiments of the present application, the locking unit 503 is further configured to lock all areas corresponding to the established walking route in response to a locking instruction.

The unlocking unit 504 is further configured to unlock the all areas in response to an unlocking instruction.

In some embodiments of the present application, the locking unit 503 is further configured to lock an area corresponding to a locking instruction when receiving the locking instruction sent by a handheld terminal.

The unlocking unit 504 is further configured to unlock a locked area when receiving an unlocking instruction sent by the handheld terminal. An area to be locked is smaller than all areas corresponding to the walking route.

In some embodiments of the present application, the locking unit 503 is further configured to lock an area corresponding to the position information when the receiving unit 501 receives the position information sent by a handheld terminal.

The unlocking unit is further configured to unlock a locked area corresponding to the position information previously received.

In some embodiments of the present application, as shown in FIG. 7, the apparatus further includes a notification unit 509.

The notification unit 509 is configured to, after the locking unit 504 locks the determined area, send a notification that the determined area is locked and, after the establishment unit 506 establishes the walking route leading to and away from the locked area, send a notification that the walking route is established.

The units of preceding embodiments may be integrated or deployed separately and may be combined into one unit or further split into a plurality of sub-units.

Additionally, embodiments of the present application further provide an electronic device. As shown in FIG. 8, an electronic device 800 includes a memory 806, a processor 802, a communication module 804, a user interface 810, and a communication bus 808 interconnecting the components.

The memory 806 may be a high-speed random access memory, for example, a DRAM, an SRAM, a DDR RAM, or other random access solid-state memory devices. Alternatively, the memory 806 may be non-volatile, for example, one or more magnetic disk storage devices, optical disk storage devices, flash memory devices, or other non-volatile solid-state storage devices.

The user interface 810 may include one or a plurality of output devices 812, and one or a plurality of input devices 814.

The memory 806 stores an instruction set executable by the processor 802, including a computer program for implementing processing flows in preceding embodiments. The processor performs the steps of the anomaly processing method of an AGV when executing the computer program.

Additionally, embodiments of the present application further provide a computer-readable storage medium storing the computer program. When executed by the processor, the computer program causes the steps of the anomaly processing method of an AGV to be performed.

In view of the preceding, in the present application, an area affected when an AGV is abnormal is determined according to anomaly processing information sent when the AGV is abnormal, and then the area is locked; when the anomaly processing ends, the locked area is unlocked. In the solutions, only the areas related to the abnormal AGV are locked, thereby mitigating the effect of the AGV anomaly and enhancing the operating efficiency of AGVs on the entire site.

In embodiments of the present application, part of areas corresponding to the position of an abnormal AGV can be locked effectively, effectively mitigating the effect on the processing efficiency of the entire site during anomaly processing.

In embodiments of the present application, the technology of locking the walking route of the operator is used, enabling the operator to reach the locked area safely, quickly, and conveniently.

The preceding are only preferred embodiments of the present application and are not intended to limit the present application. Any modifications, equivalent substitutions, improvements, and the like within the spirit and principle of the present application are within the scope of the present application.

1. An anomaly processing method of an automated guided vehicle (AGV), comprising:
receiving anomaly processing information sent by an AGV control device in response to a first AGV being abnormal;
determining, according to the anomaly processing information, an area affected in response to the first AGV being abnormal;
locking the determined area; and
unlocking the locked area in response to an anomaly processing ending.

2. The method of claim 1, wherein
the anomaly processing information comprises a velocity of the abnormal first AGV and position information of the abnormal first AGV; and
determining, according to the anomaly processing information, the area affected in response to the first AGV being abnormal comprises:
determining, according to a preset correspondence between velocities and area sizes, an area size corresponding to the velocity of the abnormal first AGV and determining, according to the area size and the position information of the abnormal first AGV, the area affected in response to the first AGV being abnormal, wherein
a higher velocity corresponds to a larger area.

3. The method of claim 1, wherein
the anomaly processing information comprises an anomaly type of the first AGV and position information of the abnormal first AGV; and
determining, according to the anomaly processing information, the area affected in response to the first AGV being abnormal comprises:
determining, according to a correspondence between anomaly types and area sizes, an area size corresponding to the anomaly type of the first AGV and determining, according to the area size corresponding to the anomaly type of the first AGV and the position information of the abnormal first AGV, the area affected in response to the first AGV being abnormal.

4. The method of claim 1, wherein
the anomaly processing information comprises position information of the abnormal first AGV; and
determining, according to the anomaly processing information, the area affected in response to the first AGV being abnormal comprises:
determining, according to predivided areas and the position information of the abnormal first AGV, an area corresponding to the position information of the abnormal first AGV and determining, according to the area corresponding to the position information of the abnormal first AGV, the area affected in response to the first AGV being abnormal.

5. The method of claim 4, wherein
the predivided areas are divided according to functional areas of a site, and areas after division are:
a sorting area, a charging area, and a queuing area; or
a sorting area, a charging area, and a plurality of workstation areas.

6. The method of claim 1, after locking the determined area and before unlocking the locked area, the method further comprising:
in response to determining that a destination point of a second AGV belongs to the locked area, dispatching the second AGV to an area outside the locked area, or in response to determining that the second AGV has another destination outside the locked area, dispatching the second AGV to the another destination,
wherein the area outside the locked area is a free area determined according to a current operation of AGVs.

7. The method of claim 1, after locking the determined area and before unlocking the locked area, the method further comprising:
in response to determining that a passing point of a third AGV belongs to the locked area, causing the third AGV to re-apply for a route due to failed locking after the third AGV reaches the locked area; or setting the locked area to a hot area and causing the third AGV to plan a route not passing through the hot area in a process of dynamic route planning.

8. The method of claim 1, after locking the determined area and before unlocking the locked area, the method further comprising:
assessing, in real time, the area determined to be locked, and locking an entire functional area corresponding to the area determined to be locked in response to a size of the area determined to be locked exceeding a preset area size, or in response to a degree of congestion caused by locking the area exceeding a preset degree, or in response to a number of destination points or passing points in the area determined to be locked exceeding a threshold.

9. The method of claim 1, further comprising:
establishing a walking route leading to and away from the locked area, and performing locking and unlocking processing of the walking route to enable, when the walking route is locked, an operator to go through the walking route, to reach the locked area, and then to process the abnormal first AGV.

10. The method of claim 9, wherein a rule of establishing the walking routes is as follows:
caused congestion is the slightest on a site; or
a distance between a current position and the locked area is the shortest; or
a distance from the locked area to a periphery of the site is the shortest.

11. The method of claim 9, wherein performing locking and unlocking processing of the walking route comprises:
locking all areas corresponding to the walking route; and
unlocking the all areas.

12. The method of claim 9, wherein performing locking and unlocking processing of the walking route comprises:
in response to receiving a locking instruction sent by a handheld terminal, locking an area corresponding to the locking instruction, and in response to receiving an unlocking instruction sent by the handheld terminal, unlocking the locked area,
wherein the received area to be locked is smaller than all areas corresponding to the walking route.

13. The method of claim 9, wherein performing locking and unlocking processing of the walking route comprises:
in response to receiving position information sent by a handheld terminal, locking an area corresponding to the position information, and unlocking a locked area corresponding to position information previously received.

14. The method of claim 9, wherein performing locking and unlocking processing of the walking route comprises:
in response to receiving a locking instruction sent by a device with a function of code-scanning and locking, locking a corresponding area, and in response to receiving an unlocking instruction sent by the device, unlocking the locked area, wherein
the device advances in a manner of locking positions one by one and passing through areas corresponding to the walking route in a manner of releasing the locked positions one by one.

15. The method of claim 9, further comprising:
after locking the determined area, sending a notification that the determined area is locked; and
after establishing the walking route leading to and away from the locked area, sending a notification that the walking route is established.

16-25. (canceled)

26. An electronic device, comprising a memory, a processor, and a computer program stored in the memory and executable on the processor, wherein the processor is configured to:
receive anomaly processing information sent by an AGV control device in response to a first AGV being abnormal;
determine, according to the anomaly processing information, an area affected in response to the first AGV being abnormal;
lock the determined area; and
unlock the locked area in response to an anomaly processing ending.

27. A computer-readable storage medium, the storage medium storing a computer program, wherein when executed by a processor, the computer program performs:
receiving anomaly processing information sent by an AGV control device in response to a first AGV being abnormal;
determining, according to the anomaly processing information, an area affected in response to the first AGV being abnormal;
locking the determined area; and
unlocking the locked area in response to an anomaly processing ending.
